(19) United States
(12) Patent Application Publication
(10) Pub. No.: US 2025/0281945 A1
(43) Pub. Date: Sep. 11, 2025

(54) CLEANING DEVICE

(71) Applicant: John Bailey, Grand Rapids, MI (US)

(72) Inventor: John Bailey, Grand Rapids, MI (US)

(21) Appl. No.: 19/063,971

(22) Filed: Feb. 26, 2025

Related U.S. Application Data
(60) Provisional application No. 63/561,511, filed on Mar. 5, 2024.

(51) Int. Cl. B08B 1/30

(52) U.S. Cl. CPC B08B 1/30

(57) ABSTRACT

A cleaning device for cleaning an article having an optical and/or digital surface, the cleaning device including a body having a receptacle and an opening therein. The opening being in communication with the receptacle and sized to allow the article to be at least partially inserted into the receptacle. The cleaning device further includes a cleaning surface located in the receptacle for cleaning the optical or digital surface of the article when at partially inserted into the receptacle, and a base configured with a clip to mount the body to a strap or a planar member.

### CROSS REFERENCE TO RELATED APPLICATION

The present application claims priority of U.S. provisional patent application Ser. No. 63/561,511, filed on Mar. 5, 2024, which is hereby incorporated herein by reference in its entirety.

### TECHNICAL FIELD AND BACKGROUND

The present disclosure relates to a cleaning device for cleaning an article with an optical and/or digital surface, such as a lens, such as on eyewear, and a screen, such as screen of a smartphone, laptop, television, or handheld gaming device.

### SUMMARY

A cleaning device for cleaning an article with an optical and/or digital surface. The cleaning device includes a body and a base. The body has a receptacle surrounded by a sidewall, which has an opening therein. The opening is in communication with the receptacle and sized to allow the article to be at least partially inserted into the receptacle. The cleaning device also includes a cleaning surface located in the receptacle for cleaning the optical or distal surface of the article when the article is at partially inserted into the receptacle. The base is configured with a clip to mount the body to a strap or planar member.

In one aspect, the receptacle comprises a first receptacle, and the base includes a second receptacle for receiving the strap or planar member therein. For example, the base may include a base wall and an arm that is spaced from the base wall to form the second receptacle therebetween.

In a further aspect, the arm is configured to releasably restrain the strap or planar member in the second receptacle.

In yet a further aspect, the base includes a second arm, with the first and second arms having distal ends forming a space therebetween, which is in communication with the second receptacle, thus allowing a strap or planar member to be inserted into the second receptacle through the space between the distal ends of the two arms.

According to yet another embodiment, in any above claim, the sidewall comprises a U-shaped side wall forming a base wall and an outer wall, wherein the base is joined with the base wall.

In any of the above cleaning devices, the base and the body may be formed from a plastic material, and optionally the same type of plastic material.

In other embodiments, the base is integrally formed with the body, and optionally integrally formed with the base wall of the body.

In an alternate embodiment, the base is releasably coupled to the body. For example, the base may comprise a base unit that is releasably coupled to the base wall of the body.

In one embodiment, the base unit is releasably coupled to the base wall of the body by one or more couplers, such as one or more magnets, one or more snap-fit couplers, or one or more slid-in clip couplers.

Optionally, the base unit and/or the body may also have a guide structure.

In any of the devices with a separate base and body, the body may include an outer perimeter defining a footprint of the body, with the base unit having an outer perimeter defining a footprint of the base unit which is aligned with the footprint of the body.

In another embodiment, the cleaning surface comprises a first cleaning surface, with the cleaning device further comprising a second cleaning surface on an exterior surface of the body.

In any of the above, the first cleaning surface and/or the second cleaning surface comprise microfiber cloth. The cloth may be supported by a reforming material, such as cotton, gel, or silicone that allows the microfiber cloth to better conform to a surface, such as surface optical or digital surface.

In another embodiment, a cleaning device kit, for cleaning an article having an optical and/or digital surface, includes a cleaning device having a body, a first base configured to mount to the body and to mount the body to a first component, and a second base configured to mount to the body and to mount the body to a second different component.

In a further embodiment of the cleaning device kit, the body has a receptacle for receiving the article therein.

In a further embodiment, the receptacle forms a first receptacle, and the first base includes a second receptacle for receiving the first component therein. For example, the first base may include a base wall and an arm, which form the second receptacle and are configured to releasably restrain the first component in the second receptacle.

In further embodiment, the first base includes a second arm, with the distal ends of the first and second arms forming a space therebetween, which is in communication with the second receptacle and allowing the first component to be inserted into the second receptacle through the space.

In any of the above kits, each of the first base and the second base is releasably coupled to the body by one or more couplers, such as magnets, snap-fit couplers, or slid-in clip couplers.

### BRIEF DESCRIPTION OF THE DRAWINGS

FIG. 1A is a perspective view of a cleaning device for cleaning articles with an optical or digital surface;

FIG. 1B is an exploded perspective view of the cleaning device of FIG. 1A;

FIG. 2 is a top perspective view of the body of the cleaning device;

FIG. 3 is a bottom plan view of the body of FIG. 2;

FIG. 4 is a side elevation view of the body of FIG. 2;

FIG. 5 is an end elevation view of the body of FIG. 2;

FIG. 6 is a perspective view of the base of the cleaning device;

FIG. 7 is a top plan view of the base of FIG. 6;

FIG. 8 is an end elevation view of the base of FIG. 6;

FIG. 9 is a side elevation view of the base of FIG. 6; and

FIG. 10 is an exploded perspective view of a cleaning device kit.

### DETAILED DESCRIPTION

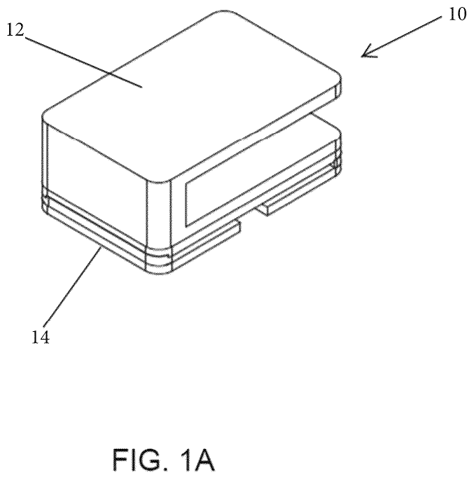

Referring to FIGS. 1A and 1B, the numeral 10 generally designates a cleaning device that is configured to clean one or more articles with an optical and/or digital surface, such as eyewear, smartphone, laptop, television, or handheld gaming device, or the like. As will be more fully described below, the cleaning device may include one or more bases that are configured to allow the cleaning device to be mounted or secured to one or more different components, such as straps, including seat belt straps, backpack straps, pet harness, or the like. When a single base is provided it may be an integral part of the cleaning device or it may be separable. Further the cleaning device is configured with one or more cleaning surfaces that allow a user to clean an article with the cleaning device either while attached to the base or when removed from the base.

Referring again to FIGS. 1A and 1B, cleaning device 10 includes a body 12 and a base 14. Base 14 may be integrally formed with body 12 or may be separately formed (as shown) but configured to couple to the body so that the body 12 may be removed and used separately and apart from base 14. As noted, body 12 may include one or more cleaning surfaces 16, 18 for cleaning the optical or digital surface of an article. For example, cleanings surfaces 16, 18 may be each formed from a fabric, such as a microfiber material, which is coupled to the body 12, for example, via an adhesive. Optionally, cleaning surfaces 16, 18 may be backed (inserted between body and the fabric) by a reforming base, such as cotton, gel, or silicone, which introduces a controlled amount of friction during the cleaning process and may also allow the fabric to better conform to the optical or digital surface.

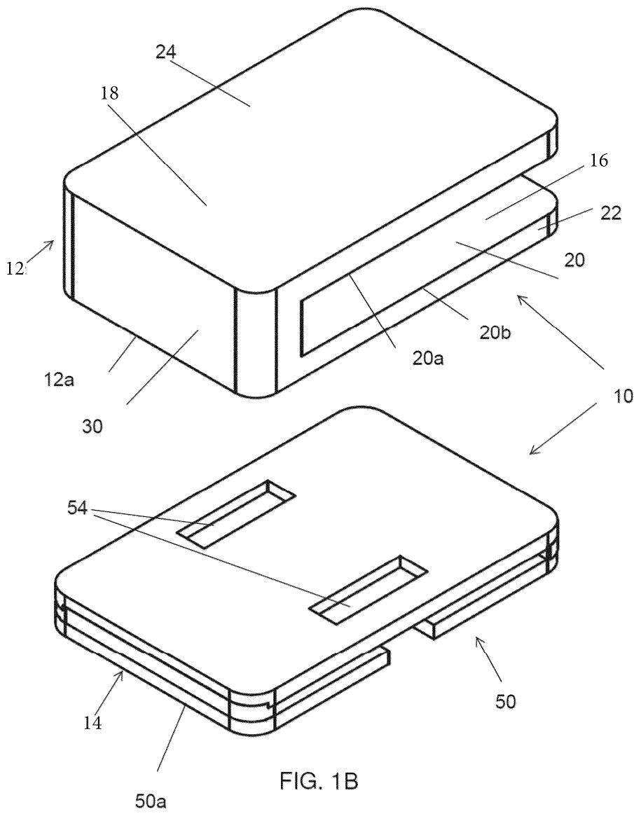

As best seen in FIGS. 1A, 1B, 2, and 4, body 12 includes a receptacle 20, which is sized to receive the article, noted above, at least partially, therein. Cleaning surface 16 may be mounted in receptacle 20 on at least one surface of the receptacle, and optionally on opposing surfaces 20a. 20b to clean opposed sides of the article in the case of eyewear or so that it is agnostic to the orientation of the article.

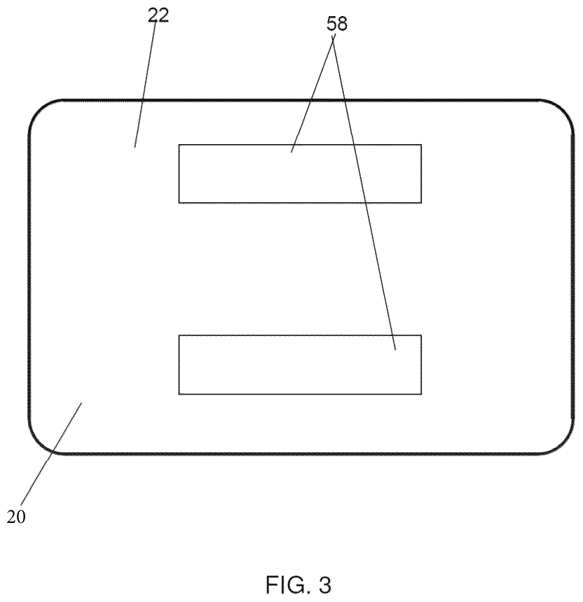

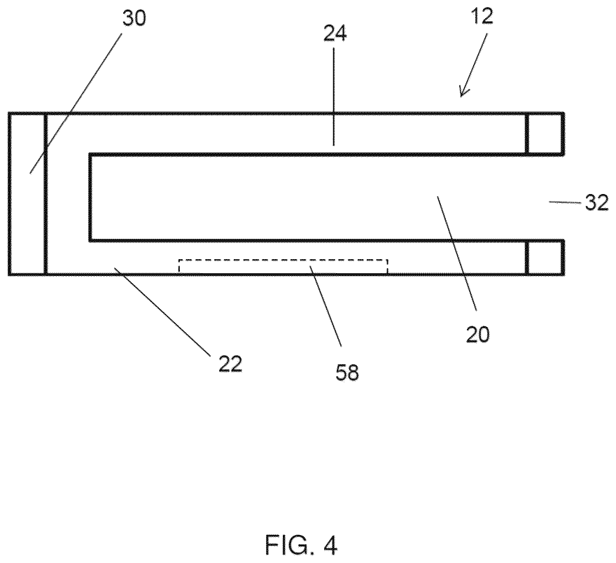

In the illustrated embodiment, body 12 includes a base wall 22 and an outer wall 24 with the receptacle 20 formed between the base wall 22 and the outer wall 24. The proximal ends of the base wall 22 and the outer wall 24 are joined together by an end wall 30, and their opposed distal ends are spaced to form an opening 32 (FIG. 4) that is in communication with receptacle 20 and sized to permit the article to be at least partially extend into receptacle 20. Once inserted into the receptacle 20, the article can then be cleaned by the cleaning surface or surfaces 16 provided in the receptacle 20. For example, the cleaning surface or surfaces 16, 18 may cover the entire side of the inwardly facing side of base wall 22 and/or outer wall 24 or may just cover a portion of the respective surfaces of the body 12.

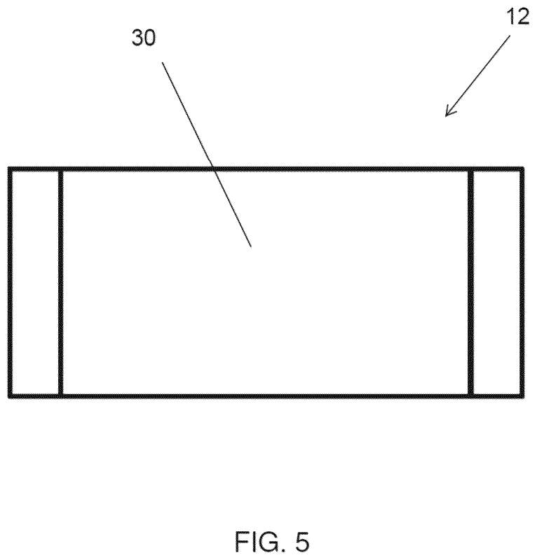

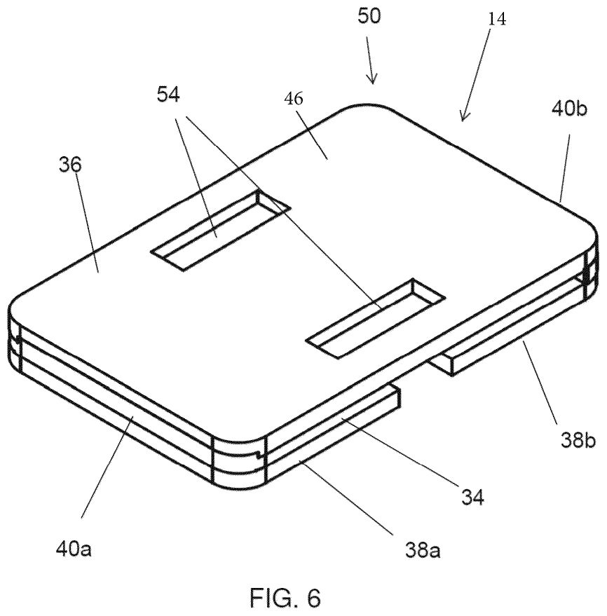

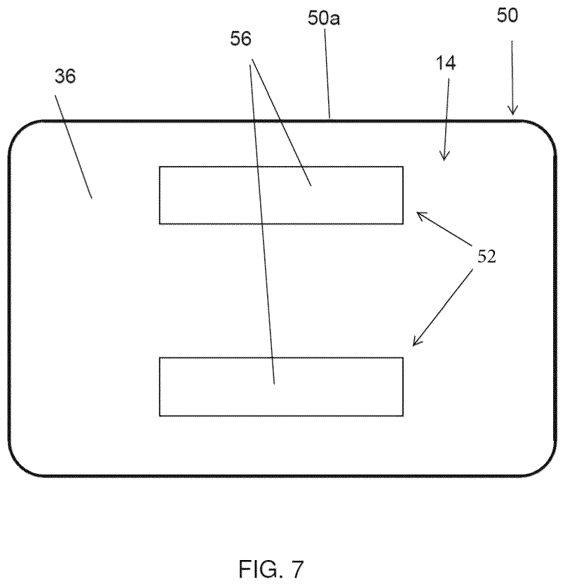

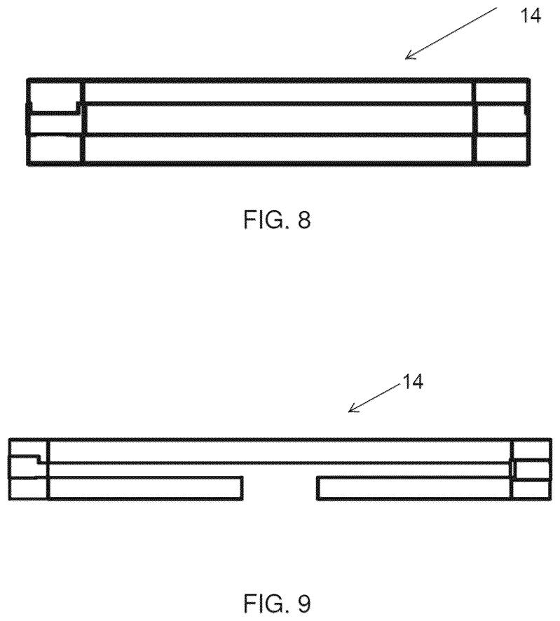

Referring to FIGS. 6 and 7, as noted above, base 14 is configured to mount to a component. In the illustrated embodiment base 14 is configured as a clip to mount to a strap, such as a seat belt or backpack strap, or other bag straps. However, it should be understood that base 14 may be configured to fit in a phone adaptor, a car visor, clothing (belts or pant or pockets), for example. In the illustrated embodiment, base 14 includes a receptacle 34 for receiving the strap or planar member therein. For example, the base 14 may have a U-shaped cross-section formed by a base wall 36 and an arm 38a that is joined with base wall 36 via an end wall 40a and spaced from the base wall 34 to form the receptacle therebetween. The arm 38a is configured to releasably restrain the strap or planar member in the receptacle 36. For example, the arm 38a may be formed from a material (described more fully below) and sized such that it can flex and form a spring so that when the component is inserted into the receptacle the component is held therein by friction. Arm 38a may have a gripping surface formed on the side facing base wall 36 to enhance the grip on the component.

Optionally, base 14 may include a second arm 38b, which is similarly joined with base wall 36 by an end wall 40b. The first and second arms 38a, 38b each have a distal end, which form a space therebetween and which is in communication with the receptacle 34, thus allowing the component, such as the strap or planar member to be inserted into the receptacle 34 through the space between the distal ends of the two arms.

As noted, the base 14 may be releasably coupled to the body 12. For example, the base may form a base unit 50 that is releasably coupled to the base wall 22 of the body 12. In the illustrated embodiment, the base unit 50 is releasably coupled to the base wall of the body by one or more couplers 52 (FIG. 7), such as one or more magnets, one or more snap-fit couplers, or one or more slid-in clip couplers. For example, when provided by magnets, base wall 46 may include recesses 54 (FIGS. 1A and 6) to receive the magnets 56 (FIG. 7) therein which may be press fit or secured therein by an adhesive or the like.

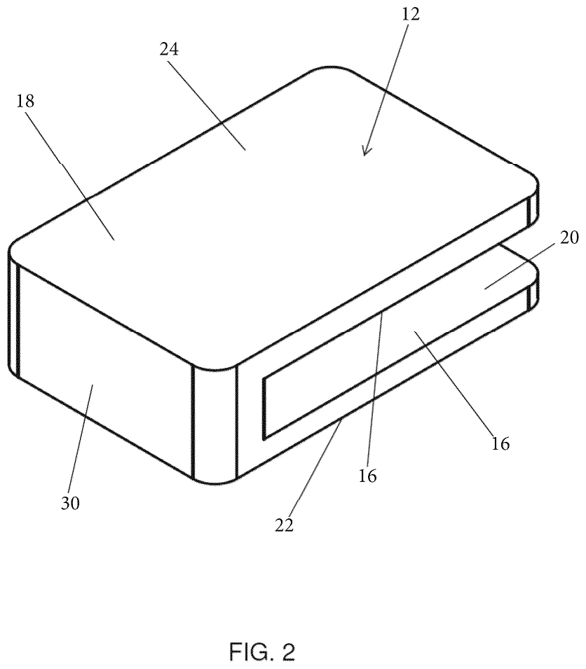

Referring to FIG. 3, corresponding couplers 58 may be provide in body 12. For example, when base 14 includes magnets, couplers 58 may also comprise magnets or may comprise ferromagnetic elements, such as plates, held in recesses formed in base wall 22 of body 12, either by friction or by mechanical interlock or by adhesion. Alternately, when forming base 12 (as more fully described below), base 12 may have ferromagnetic elements formed therein, such as by molding. Alternately, when couplers 52 are configured as mechanical couplers, couplers 58 may be configured as recesses to receive and retain couplers 52 therein, such as by friction fit or the like.

In addition, the base unit 50 and/or the body 12 may have one or more guide structures to guide the body into engagement with the base. The connection between the base unit and the body may be further reinforced by rails or divots on the mating surfaces of the base unit and the body, ensuring a precise and stable fit. The design allows the slightly smaller cleaning unit to be easily attached to or detached from the base unit, facilitating its use and enhancing the product's overall utility.

In the illustrated embodiment, the body 12 may include an outer perimeter 12a that defines a footprint of the body 12. The base unit 50 also has an outer perimeter 50a that defines a footprint of the base unit 50, which is aligned with the footprint of the body 12 so that they may form a contiguous outer surface with each other, as best seen in FIG. 1A. Alternately, cleaning device 10 may have a stepped profile. For example, the body 12 may have a larger footprint to provide a gripping edge or surface for the body 12, or the base unit 50 may have a larger footprint to provide a gripping edge or surface for the base unit 50.

As noted above, cleaning device 10 may include one or more cleaning surfaces 16, 18, with one cleaning surface 16 located in receptacle 20, and the other cleaning surface 18 provided on an exterior surface of the body 12, such as the outer surface of the outer wall 24.

In any of the above, the cleaning surfaces comprise a microfiber cloth patch. The cloth may be supported directly on the surface of the body or by a reforming material, such as cotton, gel, or silicone that allows the microfiber cloth to better conform to a surface, such as surface optical or digital surface. This combination not only can maintain the shape of the receptacle but also introduces a controlled amount of friction during the cleaning process. This friction allows for effectively dislodging and removing debris from the surface being cleaned, thereby enhancing the overall cleaning efficacy.

In other embodiments, the base 14 may be integrally formed with the body 14, either by applying an adhesive or by molding, and optionally integrally formed with the base wall 22 of the body 12.

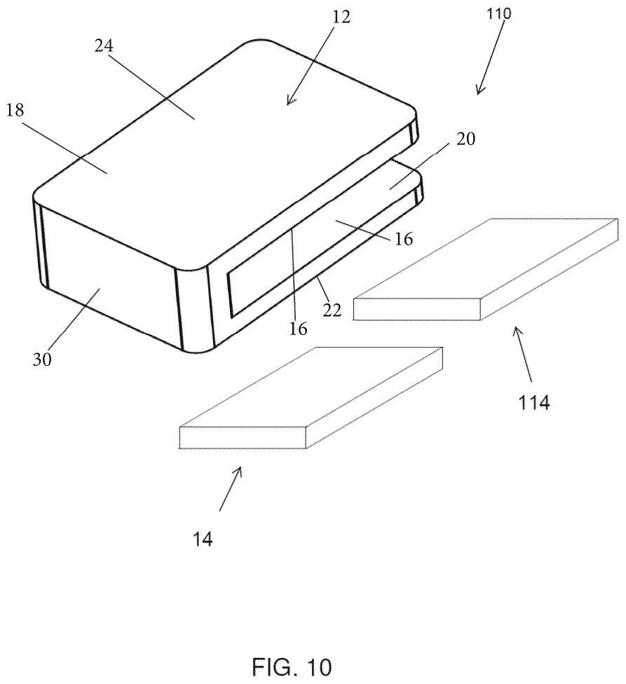

Referring to FIG. 10, a cleaning device kit 110 may be provided with body 12 and base 14, and a second base 114. For example, as noted above, base 14 may be configured to mount the body to a first component, such as a strap or other thin planar member, such as a visor, while the second base 114 configured to mount to the body to a second different component, such as a pillar in a vehicle or a desk or other generally planar surfaces. Base 114 may similarly form a base unit with one or more couplers for engaging body 12 but may be configured with alternate clip design or may have couplers, such as magnets, VELCRO patches or strips, for example, to mount the body to the second component. For additional details of body 12 and base 14, reference is made to the above embodiments.

In any of the above kits, as would be understood from the above description, each of the first base and the second base may be releasably coupled to the body by one or more couplers, such as magnets, snap-fit couplers, or slid-in clip couplers.

In any of the above base units, the base unit provides a stable foundation for the cleaning device enabling easy attachment and access. Designed for versatility, the base unit can be adapted for various settings and uses, including, as noted, attachment to vehicle seatbelts, clothing (belts and pants), backpacks, pet harnesses, and stationary locations like desks or walls. This flexibility ensures that the cleaning device is conveniently available for use in a wide range of scenarios.

In any of the above cleaning devices, the base(s) and the body may be formed from a plastic material, and optionally the same type of plastic material. The components of the cleaning devices may be manufactured from a wide variety of moldable materials, such as plastics, ensuring versatility in production and use. While PLA (Polylactic Acid) and ABS (Acrylonitrile Butadiene Styrene) plastics are highlighted for their durability, flexibility, and environmental sustainability, the design is not limited to these materials. The cleaning device may be formed a wide range of plastic materials, including but not limited to PET (Polyethylene Terephthalate), PVC (Polyvinyl Chloride), PE (Polyethylene), PP (Polypropylene), and polycarbonate. This diverse selection allows for customization based on specific requirements such as rigidity, transparency, biodegradability, and resistance to heat, chemicals, and impact. The ability to utilize various plastics also enables the adaptation of the product to different environmental and regulatory standards, catering to a global market.

As would be appreciated from the above description, the cleaning device revolutionizes the care of optical and digital devices through its innovative design and functional features. The cleaning devices receptacle, with its microfiber cleaning surface and optional supportive backing materials, ensures effective and safe cleaning for a variety of devices. Coupled with the versatile base unit and secure connection mechanism(s), the cleaning devices described herein offer a practical, reliable, and accessible solution for maintaining the cleanliness and functionality of essential devices in today's digital age.

I claim:

1. A cleaning device for cleaning an article having an optical and/or digital surface, said cleaning device comprising
a body having a receptacle and an opening therein, said opening in communication with said receptacle and sized to allow the article to be at least partially inserted into said receptacle;
a cleaning surface located in said receptacle for cleaning the optical or digital surface of the article when at partially inserted into said receptacle; and
a base configured with a clip to mount said body to a strap or a planar member.

2. The cleaning device of claim 1, wherein said receptacle comprises a first receptacle, said base including a base wall and at least one arm spaced from said base wall to form a second receptacle for receiving the strap or planar member therein.

3. The cleaning device of claim 2, wherein said arm is configured to releasably restrain the strap or planar member in said second receptacle.

4. The cleaning device of claim 3, wherein said base includes a second arm, said first and second arms having distal ends forming a space therebetween, said space being in communication with said second receptacle and allowing a strap or planar member to be inserted into said second receptacle through said space.

5. The cleaning device of claim 1, wherein said body comprises a U-shaped side wall forming a base wall and an outer wall, said base joined with said base wall.

6. The cleaning device of claim 1, wherein said base and said body are formed from a plastic material, and optionally the same type of plastic material.

7. The cleaning device of claim 6, wherein said base is integrally formed with said body.

8. The cleaning device of claim 1, wherein said base is integrally formed with said base wall of said body.

9. The cleaning device of claim 1, wherein said base is releasably coupled to said body.

10. The cleaning device of claim 9, wherein said body includes a base wall, and said base comprises a base unit and is releasably coupled to said base wall of said body.

11. The cleaning device of claim 10, wherein said base unit is releasably coupled to said base wall of said body by one or more couplers.

12. The cleaning device of claim 11, wherein one of said couplers comprises a guide structure.

13. The cleaning device of claim 9, wherein said body includes an outer perimeter defining a footprint of said body, said base unit having an outer perimeter defining a footprint of said base unit, and wherein said footprint of said body is aligned with said footprint of said base unit.

14. The cleaning device of claim 1, wherein said cleaning surface comprises a first cleaning surface, further comprising a second cleaning surface on an exterior surface of said body.

15. The cleaning device of claim 14, wherein said first cleaning surface and/or said second cleaning surface comprise microfiber cloth, and optionally wherein the microfiber cloth is supported by a reforming material, such as cotton, gel, or silicone.

16. A cleaning device kit for cleaning an article having an optical and/or digital surface, said cleaning device kit comprising:
a cleaning device having a body with a first receptacle surrounded by a sidewall, said sidewall having an opening therein, said opening in communication with said first receptacle and sized to allow the article to be at least partially inserted into said first receptacle, said body having at least one cleaning surface located in said receptacle for cleaning the optical or distal surface of the article when at partially inserted into said receptacle; and
a first base configured to mount to said body and to mount said body to a first component; and
a second base configured to mount to said body and to mount said body to a second component.

17. The cleaning device kit of claim 16, wherein said receptacle comprises a first receptacle, said first base including a base wall and at least one arm spaced from said base wall to form a second receptacle for receiving the first component therein.

18. The cleaning device kit of claim 17, wherein said arm is configured to releasably restrain the first component in said second receptacle.

19. The cleaning device kit of claim 18, wherein said base includes a second arm, said first and second arms forming a space therebetween, said space being in communication with said second receptacle and allowing the first component to be inserted into said second receptacle through said space.

20. The cleaning device kit of claim 16, wherein each of said first base and said second base is releasably coupled to said body by one or more couplers.
